(19) United States
(12) Patent Application Publication
(10) Pub. No.: US 2015/0120794 A1
(43) Pub. Date: Apr. 30, 2015

(54) PERSONAL DATA MODELLER

(71) Applicants: Carol GLYNN, (US); Paul PHELAN, (US)

(72) Inventors: Paul Phelan, Wicklow (IE); Carol Glynn, Wicklow (IE)

(21) Appl. No.: 14/398,166

(22) PCT Filed: May 2, 2013
(86) PCT No.: PCT/EP2013/059194

§ 371 Date: Oct. 31, 2014

Related U.S. Application Data
(60) Provisional application No. 61/641,597, filed on May 2, 2012.

(30) Foreign Application Priority Data
May 3, 2012 (IE) S2012/0226

(51) Int. Cl. G06F 17/30; G06F 3/0481

(52) U.S. Cl. CPC G06F 17/30091; G06F 17/30126; G06F 3/04817
USPC 707/828

(57) ABSTRACT

It is becoming more and more common for users to store personal documents or indeed copies of these documents on their computer. A difficulty for a user is how to store these documents. The present application relates to file storage on a computer and in particular provides a method and system for creating a personalized directory structure for electronically storing personal information.

### RELATED APPLICATIONS

This patent application claims the benefit of the filing date of U.S. Provisional Patent Application Ser. No. 61/641,597, filed May 2 2012 entitled “A PERSONAL DATA MODELLER” and Irish Short Term Patent Application No. S2012/0226 filed May 3 2012 entitled “A PERSONAL DATA MODELLER”, the entire contents of which are incorporated by reference herein in their entirety.

### FIELD OF THE APPLICATION

The present application relates to file storage on a computer and in particular to a method and system for creating a personalized directory structure for electronically storing personal information and rapidly accessing the data contained therein.

### BACKGROUND TO THE APPLICATION

It is becoming more and more common for users to store personal documents or indeed copies of these documents on their computer. A difficulty for a user is how to store these documents.

Certain operating systems, for example MICROSOFT WINDOWS™, create a default file structure for individual users on a computer. These default file structures typically include a “DESKTOP” folder and a “MY DOCUMENTS” folder. In the “MY DOCUMENTS” folder a number of standard sub-folders may be created for each user. These are typically “My Pictures”, “My Videos” and “My Music”. Whilst this provides the user with some options for storage of their documents it is relatively limited and based simply on whether the individual file is a music file, picture file or video file. Whilst a user may create sub-folders or indeed a structure of sub-folders, the difficulty is that this tends to be on an ad-hoc basis and accordingly the structures can become confusing with users creating multiple locations for saving related documents merely because they have forgotten the structure they have created or because the reasoning for naming folders is forgotten over time.

Another approach is to organize files by “tagging” individual files, typically by inclusion of meta data with the files. Thus a user can for example tag an image with certain key words which they may subsequently use to find the file or category of file.

Another approach used is to use a search facility to search a directory structure for a previously stored file, EXPLORER™ provides such a search function within MICROSOFT WINDOWS™ although other products such as GOOGLE DESKTOP provide an alternative. Whilst these systems are useful, an improved system is desirable.

### SUMMARY

The present applications provides a computer implemented method for creating a personalized directory structure on a computer file system disk, wherein the computer user is requested to enter a number of items of personal information (his own/his family's) and a directory location where the new directory structure will be saved. When the user has entered all of the requested data the method uses an algorithm to create a schema for a directory structure and implements the directories and sub-directories on a local or remote cloud storage location. The deployed directories have directory names customized with the names and information of the individual person/family. The user can choose to have the new directory structure populated with in-context template/example files, empty note files and website links (URL's). Accordingly, a first embodiment provides a computer implemented method for creating a personalized file directory structure for use by a user to store personal information of the user. The computer implemented method comprises the steps of obtaining an identification of a user-type from the user where the user-type identifies whether the directory structure, is for an individual or several individuals grouped together. Where grouped together they are suitably in a family unit, for example as a couple or a family comprising a couple with children. Based on the user's identification, a pre-defined directory schema for the personalized file directory structure is selected based on the identification of user-type. The computer implemented method presents the users with a series of predefined questions about their personal circumstances, for example by means of a graphical user interface. A plurality of answers are obtained from the user as to their personal circumstances for example through the graphical user interface. A personalised file directory schema is then created from the selected pre-defined directory schema based on the identified user type and the obtained plurality of answers. This personalized file directory schema has an enriched directory structure in which default directory names from the predefined schema are changed based on answers provided by the user. The resulting schema identifies the directories for the personalized file directory structure.

The user suitably provides a location for the directory structure and the method provides for placing the personalised file directory structure at this location by creating the requisite directories from the schema at said location to provide the file directory structure.

Where the user is presented with a series of questions, the selection (presentation graphically) of a subsequent question may be based on an answer obtained from a previous question. Thus certain questions may be hidden from a user until previous questions are answered with a required answer. Similarly, within a GUI certain questions may be visible initially but hidden as a result of an obtained answer.

A user may be required to select their country of residence. The method may then populate the directory structure with default directories previously defined for said selected country.

The method may populate the default directories with one or both of Local forms or URL links previously defined for said selected country.

Similarly, the user may be presented with one or more questions based on their personal circumstances including their marital status, whether they have any dependents, their employment status, their choice of transport, the nature of their residence (home) and their religion. Suitably, each of the questions has pre-defined answers from which the user may select an answer. Each pre-defined answer is associated with one or more with default directories which are inserted in the user's directory schema when the user selects the answer. Suitably, the personalized file directory structure comprises a tree directory structure with a single root sub-directory in which all of the remaining directories are contained.

The method also provides for the creation of a graphical user interface or ‘Dashboard’, which may for example be in the form of a browser accessible file or software application. The created graphical user interface provides a plurality of icons each icon having an associated link or shortcut, which may be linked through to by a user clicking the icon wherein a plurality of the associated links are to points internal to the personalized file directory structure. For example an icon with a picture of a house, when clicked links to the users house directory. This allows a user a quick and efficient method of accessing files within their directory structure without having to navigate. This is particularly advantageous where the user is accessing the directory structure on a tablet (e.g. IPAD) or mobile telephone. It may also allow access to other features associated with the user. For example associated links may be a link to a browser accessible account of the user, for example a social media account of the user, an email account of the user, a diary or schedule of the user or a web link (url) frequently used by the user.

The application also provides a system and a computer program.

These and other features will become more evident from the description which follows.

### DESCRIPTION OF DRAWINGS

FIG. 1a is an exemplary Windows-Style Graphical User Interface (GUI) in which a user may fill in a number of information fields in a first step of a method according to an embodiment of the present application;

FIG. 1b is an exemplary Browser-Style Graphical User Interface (GUI) in which a user may fill in a number of information fields in a first step of a method according to an embodiment of the present application;

FIG. 2a is a GUI corresponding to FIG. 1, with fields completed with exemplary values;

FIG. 2b is a GUI corresponding to FIG. 1b, with fields completed with exemplary values;

FIG. 3 illustrates an exemplary Work Flow Chart according to a further embodiment;

FIG. 4 illustrates examples of ‘User-Type’ Directories;

FIG. 5 illustrates an exemplary input data decision sequence flow chart for an exemplary User-Type ‘Adult’;

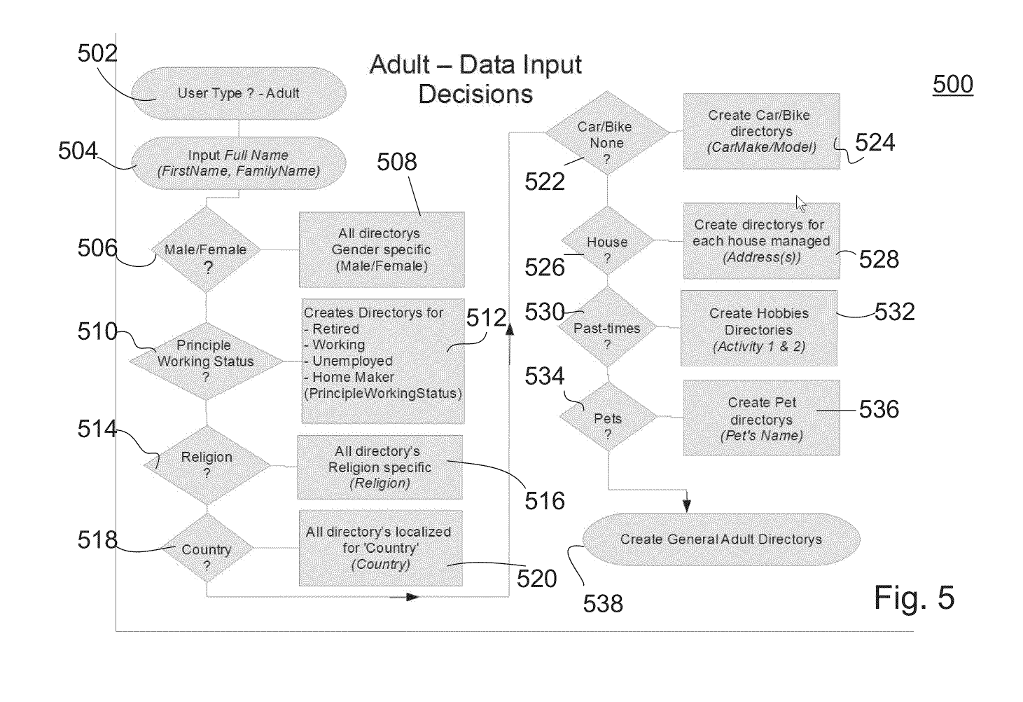

FIG. 6 illustrates an exemplary directory structure for an exemplary User type ‘Adult’ resulting from the flow of FIG. 5;

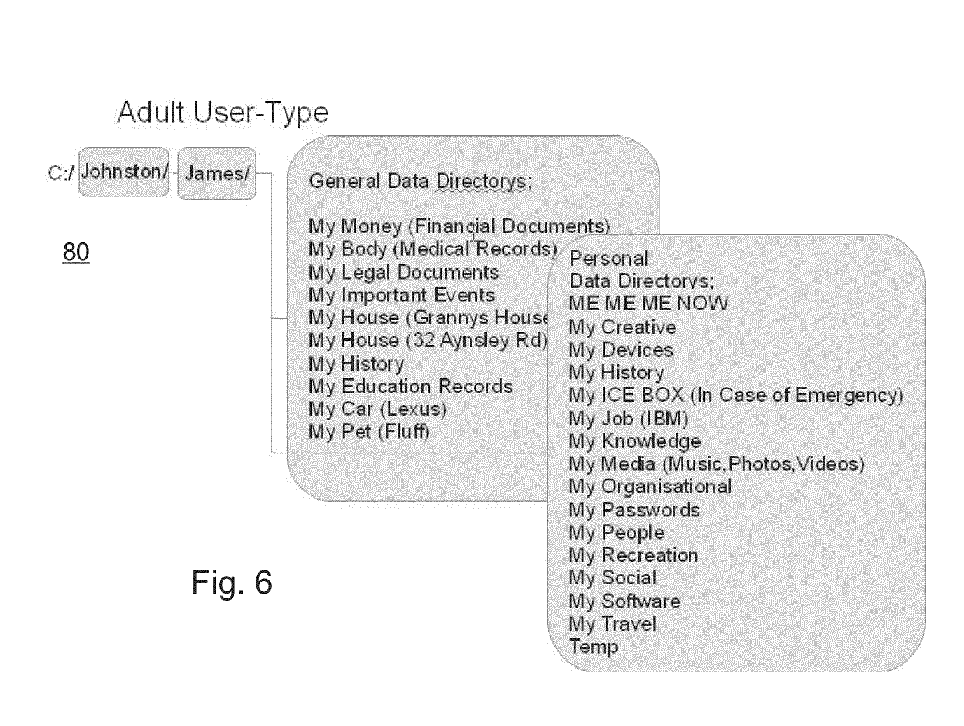

FIG. 7a illustrates an exemplary User Type ‘Family’ schema;

FIG. 7b illustrates an exemplary directory structure for the exemplary User type ‘Family’ of FIG. 7a;

FIG. 8 illustrates an exemplary flow chart for deployment of a directory structure;

FIG. 9 illustrates an exemplary flow chart of an aspect of the deployment process of FIG. 8 which generates directory names;

FIG. 10 illustrates exemplary parameters that may be employed in a ‘Directory Build Routine’;

FIG. 11 is a sequence list that may be generated to allow a User to Scan and copy documents to populate the directory structure with their data;

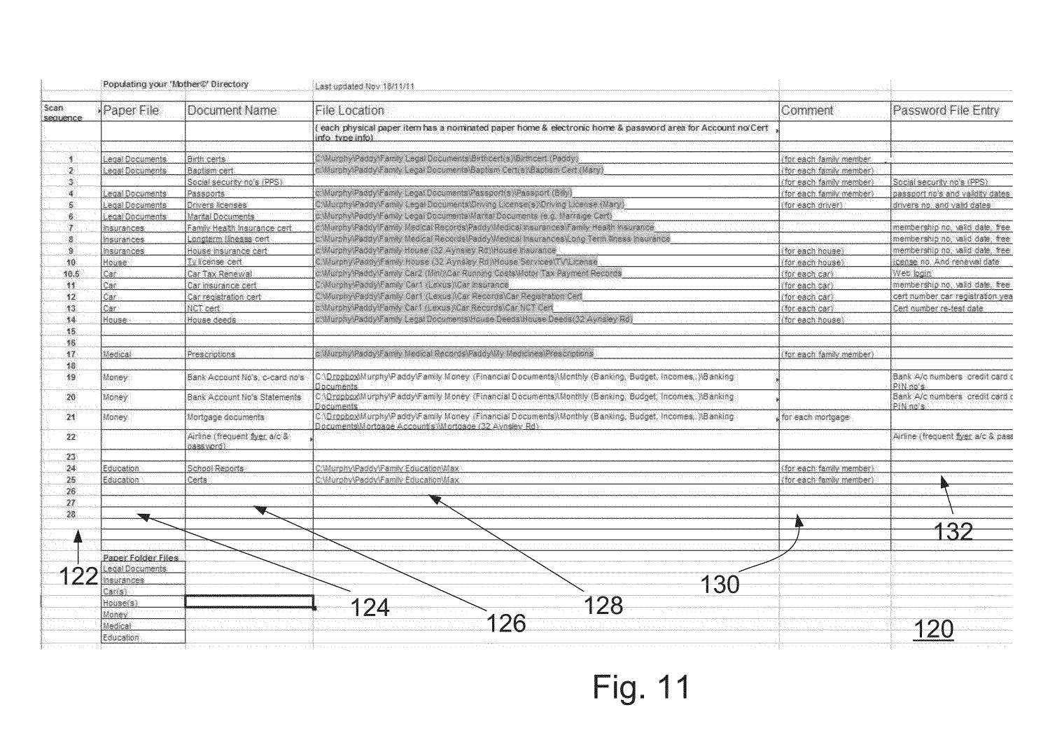

FIG. 12 is an exemplary Browser-Style Life-Dashboard;

FIG. 13 is an exemplary UserConfiguration.xml file; and

FIG. 14 is an exemplary computing machine suitable for implementing the methods and interfaces of the previous figures as a system.

### DETAILED DESCRIPTION

The present application is directed to the creation, deployment and use of a data structure referred to herein as a Personal Data Modeller or PDM within a computer system. The data structure contains a directory tree structure which may be deployed by users to allow them to organize files and documents associated with their life. The deployed directory structure may also contain template files and URL links. These template files and URL links are stored in appropriate directories within the deployed directory structure. An interface is also described that allows users to access the data contained within their PDM structure. The interface that allows users to rapidly access points within the directory tree structure will be referred to herein as the “Life-Dashboard”.

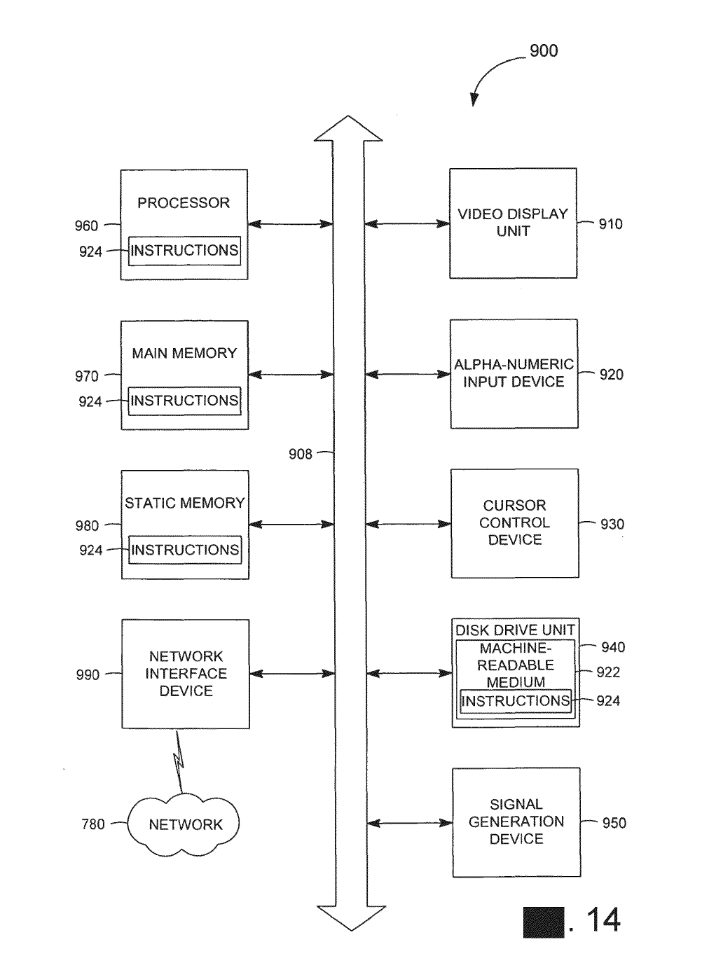

The present PDM application provides a computer implemented method which when run on a computer 900 of the type illustrated generally in FIG. 14, for example as a native OS Application or through a browser, creates a local or remote directory structure which an individual or family unit may use to store their documents and easily retrieve their documents.

The deployed directories are created as a tree of sub-directories within one root directory. Suitably, the root directory is a directory location provided on a disk drive of a user's computer or a remote cloud storage location. The local drive may be a magnetic disk drive or an electronic drive such as might be provided by flash memory. The remote storage location may be implemented by a synchronized directory service such as the DROPBOX™ service provided by Dropbox Inc. of San Francisco, GOOGLEDRIVE™ provided by Google Inc., or other similar services including Jungle Disk, Microsoft SkyDrive, TitanFile, SpiderOak, Wuala and SugarSync. Such a cloud storage service conventionally provides remote access of the data files via an internet enable computing device such as a computer/smart phone/tablet etc.

The creation and deployment process may be implemented as one integral process or separated into a number of separate stages. Thus a first stage may be the creation of a configuration file specific for the user from which the directory tree structure may be created. A second stage may be employed to generate a directory tree structure from the configuration file.

Thus the first and second stages may be implemented by separate executable application (.exe) files. For example, the output from a first stage executable file might be a configuration file. This configuration file becoming an input for the second stage.

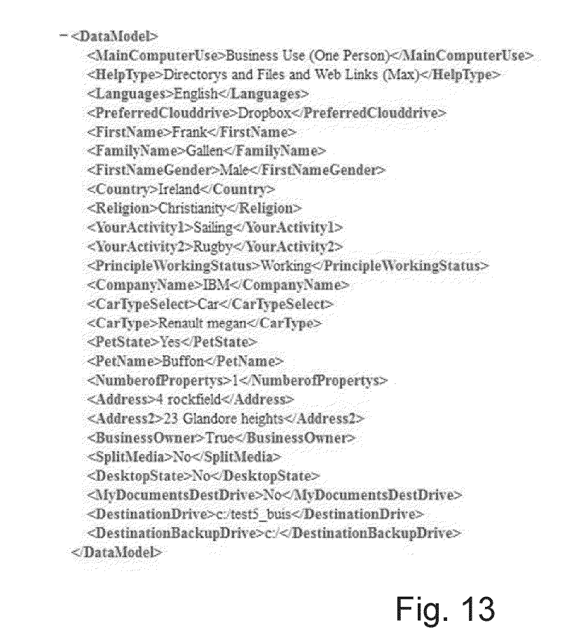

An exemplary first stage will now be described for the production of such a user configuration file (which may for example be an xml file with a name of the form UserConfiguration.xml—FIG. 13).

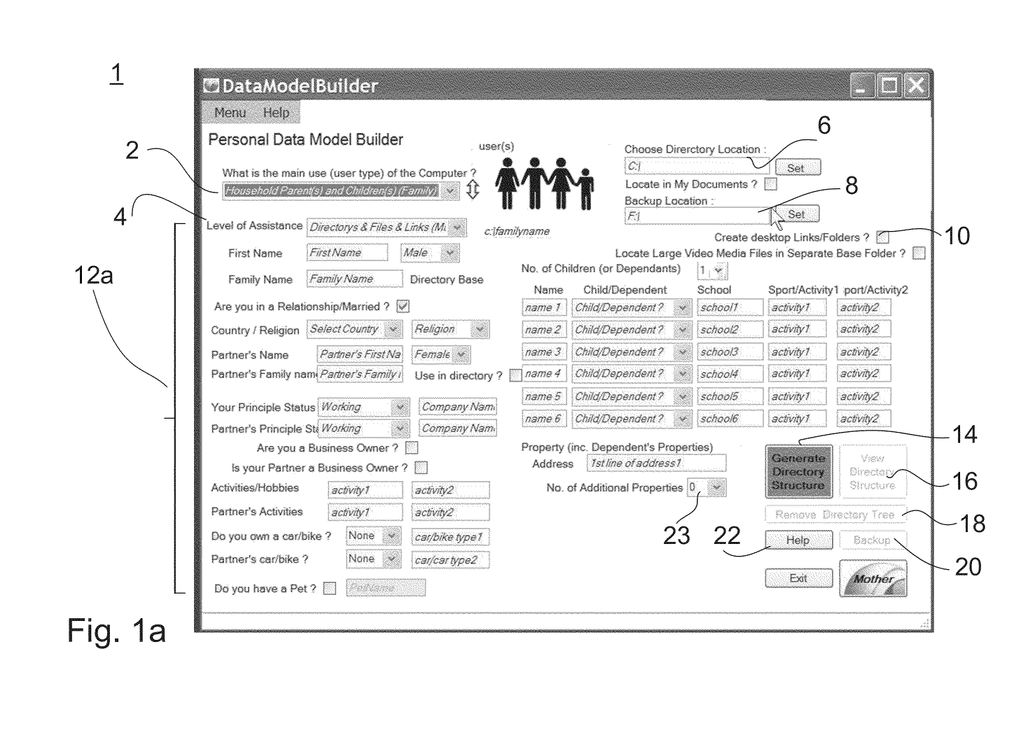

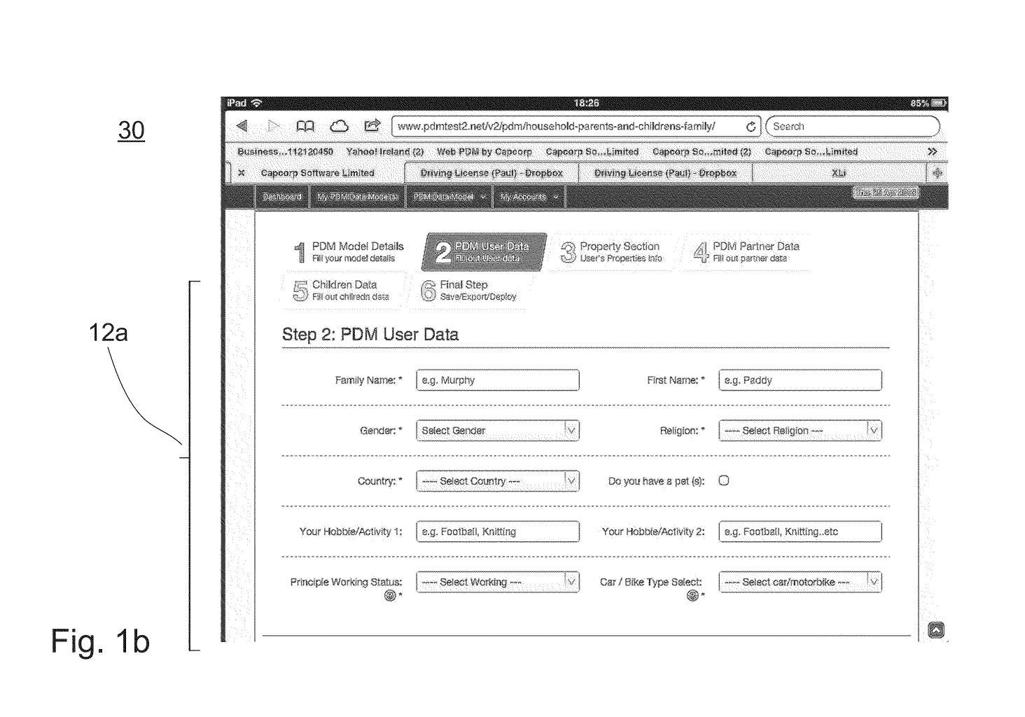

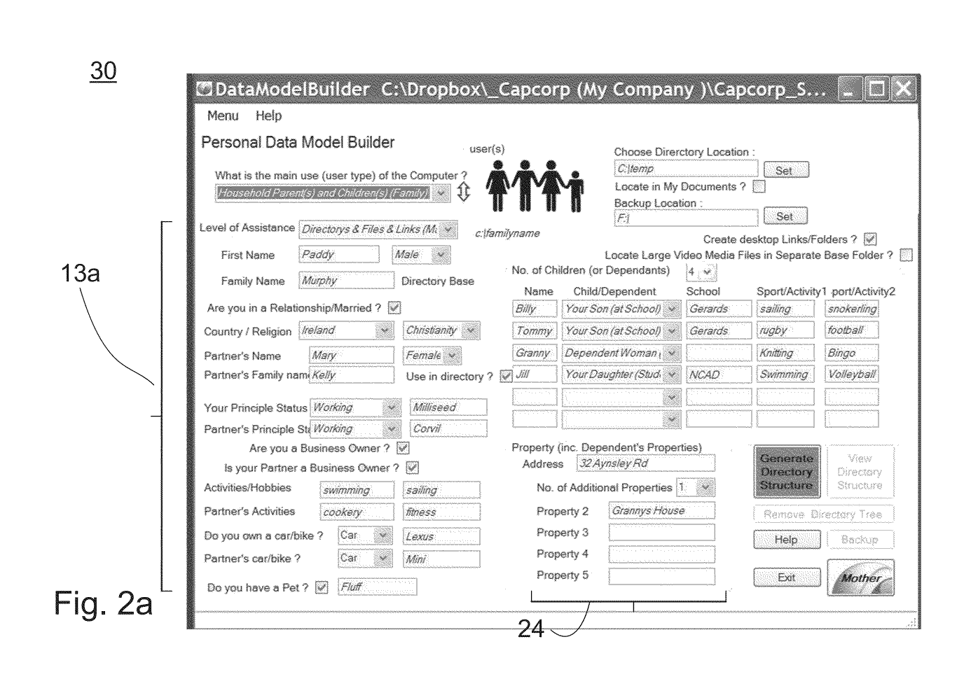

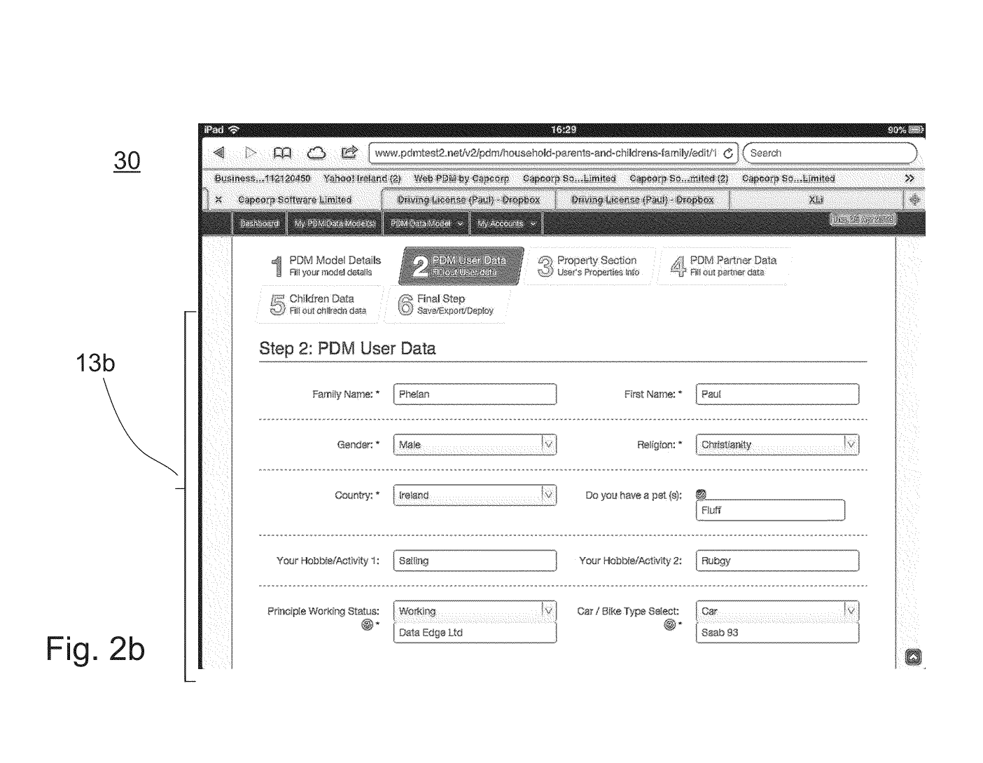

The first stage provides a Graphical User Interface which guides the user through the process of selecting a suitable user model schema and helps the user enter their personal data fields. The process ends with a completed UserConfiguration.xml file. The first stage may provide the graphical user interface directly to a user in their computer by means of an application, e.g. a WINDOWS, MAC, linux, IOS application as appropriate. An example of a WINDOWS based GUI 1 is shown in FIG. 1a with the same form having data fields completed shown in FIG. 2a. Alternatively, the first stage may be hosted on a server with a graphical user interface provided to the user by means of a webpage accessible by a browser from the user's computing device. An exemplary browser interface 30 is shown in FIG. 1b with the same form having data fields completed shown in FIG. 2b. The graphical user interface may change based on answers provided by a user, thus a subsequent question may be presented to a user based on an answer obtained from a previous question. As an example, the additional property questions 24 have been presented in FIG. 2a as a result of the user entering a value of 1 for question 23 which was defaulted to a value of 0 (No. of Additional Properties) in FIG. 1a.

The output from the first stage is a user configuration file which may be processed by the second stage.

The second stage operates may be an executable file (e.g. PDM_CMD.exe) which employs the UserConfiguration.xml file as an input.

On execution (depending on the input parameters), the binary either directly creates the directories on the storage device (local or remote) or produces an output text file.

There are a number of possible output text files, including for example; a text file, ‘UserConfig_dirlist.txt’, which lists the directorys to be created. and a text file ‘UserConfigprim_dirlist.txt’ which lists the primary directorys for the ‘Life Dashboard’ shortcuts.

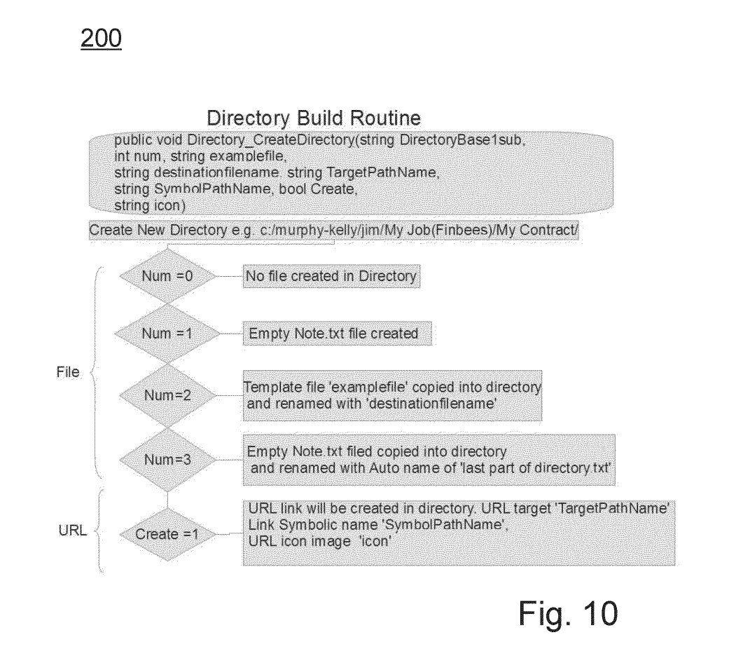

Each line represented in the output text files follows the ‘Directory Build Routine’ syntax; DirectoryBase: c:/Whelan/Family (Whelan)/Family House (190 Seafield View) *Num:2 *TemplateFile:Address_adult.txt *Destinationfilename:My House Details (191 Seabourne View).txt *Create URL:False *Target URL: *SymbolicNameForURL: *URL Icon: Ref. FIG. 10

Where the executable second stage program is implemented as a Command line executable, it may be written to accept a parameter and file identifier as input, e.g. a command line Syntax of the form ‘PDM_CMD [param] UserConfig.xml’, where PDM_CMD is the name of executable file, UserConfig.xml the users configuration file and where the parameter param may have a plurality of different values, each specifying a different mode of operation.

These modes may be, for example, as follows for the specified parameter:

0—create directorys/files/urls (only for Windows PDM)
1—create directorys/files/urls & directory_list_file
2—create directory_list_file (webPDM)
3—create primary_directory_list_file only (webPDM Dashboard)

The PDM application can take several embodiements. The pieces that may be kept consistent are the ‘PDM_CMD.exe’ executable and the ‘UserConfiguration.xml’ configuration file format.

For example, a user may download and run the executable file from a website, create their own configuration file and then deploy the directories directly onto their local/remote storage device (OS specific). Alternatively, the method may be provided as javascript or similar script which is run by the user through a browser window. Equally the method may be implemented in a distributed environment, thus the method may be partly provided on a client computing device, e.g. a client computer or smart phone, having a web browser with the remaining html/php/mysql forms and database functionality provided by a server computer operating as a (web) server. In this scenario, the same executable file (PDM_CMD.exe) as described above may be run on the server as a command line with input configuration file (UserConfiguration .xml) provided through the web interface.

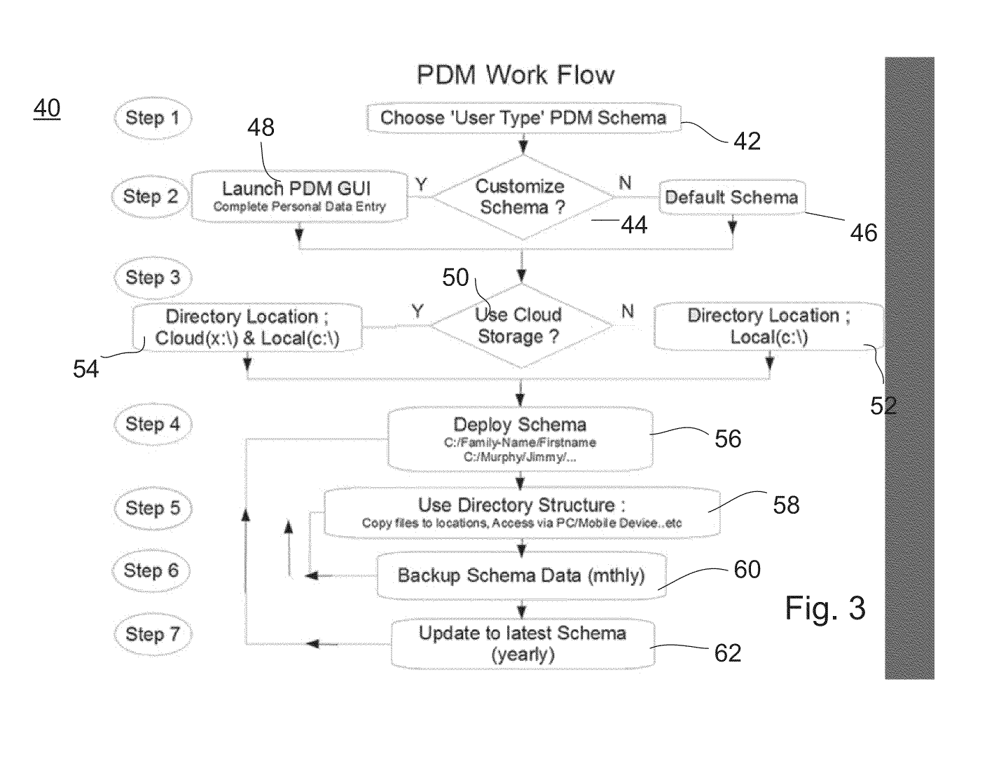

The work flow 40 of the PDM method is shown generally by example in FIG. 3.

Step 1 relates to the generic ‘user-type’ schema choice of the user. This first step 42 allows a user to select from one of several ‘user types’ for example using a drop down box 2 in the GUI 1. Examples of ‘user types’ include ‘Adult’, ‘Couple’, ‘Family’ and ‘Child’, each of which are intended to correspond to the circumstances of the user.
Step 2 relates to the personal/family information data entry by the user.
Step 3 relates to the storage location choice (local or cloud) of the user.
Step 4 is the deployment stage of the new directory structure based on the values selected\entered by the user in the first three steps;
Step 5 relates to the daily usage of the directory structure by the individual/Family including the rapid access methodology of the complimentary Life-Dashboard application.
Step 6 relates to the backup procedures to safeguard the data.
Step 7 relates to the yearly schema and template file updates.

The detail of the exemplary seven step PDM work flow will now be explained.

Step 1 provides the user with the ability to choose 42 a default “user-type”. The nature of the user type is intended to reflect the personal situation\circumstances of the user and whether they are setting it for themselves personally or a plurality of persons for example as a couple or family. Step 1 may be implemented by allowing a user to select their particular option from a drop down list 2, activating (clicking) a particular button or other suitable user interface technique known in the art. As will be explained below, the selection of the “user-type” affects the subsequent steps in the process.

In steps 1&2&3 (the data entry steps) a user is presented with a number of data fields 4, 6, 8, 10, 12, 23 to fill in. These fields take the form of a number of questions which may be presented together or directed to the user in a sequential fashion. The user may also be presented with a number of other buttons 16, 18, 20, 22 for different functionality including for example a help function. In one variation, the questions are presented to the user in a graphical user interface 1 in which a plurality of questions are presented to the user, with the user able to provide their answer to each question by typing into a text box associated with the question or by selecting an option in a drop down list or by activating a button or similar feature. Thus in the case where the data being sought is the name of the user's first Child/Dependent school and the user elects not to enter a value, the software may employ, a generic name ‘School1’. Each data field has a default value. Whilst exemplary graphical interfaces are shown in FIGS. 1a/b & 2a/b comprising a plurality of Windows-Style and HTML Browser-Style Selection boxes, radio buttons and text box input types, it will be appreciated by those skilled in the art that a variety of different methods may be employed to obtain this information from a user into a computer.

Details of each of the input fields and methods in the exemplary graphical interface presented in FIG. 1a by which a user may enter data through the graphical user interface are outlined below in Table 1.

TABLE 1

| Field Name | Description | Selections/Method |
|---|---|---|
| User Type | Computer user type | Selection Box, up/down arrow keys |
| | | auto-populate main categories and |
| | | disable unused fields: |
| | | Adult Home Use (One Person Male) |
| | | Adult Home Use (One Person Female) |
| | | Business Use (One Person) |
| | | Household Parent(s) and Children(s) |
| | | (Family) |
| | | Child Home use & School Work (One |
| | | Person) |
| | | Two Adults (Partners) |
| | | Two Adults (Female Partners) |
| | | Two Adults (Male Partners) |
| HelpType | Level of Assistance: | Selection Box |
| | Simple Directories | Basic Directorys (Min) |
| | only or include the | Directorys & Files (Medium) |
| | in-context customized | Directorys & Files & Links (Max) |
| | template files and | |
| | URL's | |
| DestinationDrive | Disk Drive and | C:/base directory location |
| | directory location | |
| | for new directory | |
| | structure | |
| | (can be a cloud | |
| | mapped directory | |
| | location) | |
| DestinationBackupDrive | Disk Drive and | C:/backup directory location |
| | directory location | |
| | where directory | |
| | structure will be | |
| | backed up (can be a | |
| | cloud mapped | |
| | directory location) | |
| FamilyName | Your Family name | Family name |
| FirstName | Your Name | Name |
| FirstNameGender | Gender | Selection Box |
| | | Male/Female |
| SpousesName | Spouse/Partners Name | Name |
| SpousesFamilyName | Spouse/Partner Family | Spouse's/Partner's Family |
| | name | name |
| SpousesNameGender | Gender | Selection Box |
| | | Male/Female |
| In a relationship? | Is this a marriage | Check Box |
| | husband/wife or | Yes/no |
| | couple type | |
| | relationship? | |
| Use | Join Family names as | Check Box |
| SpousesFamilyName | root name of directory | Yes/no |
| as part of Directory | structure? e.g. | |
| structure? | C:/murphy-kelly/ . . . etc | |
| Country | Which Country do you | Selection box |
| | live in? | All Countries Selection |
| Religion | What is the main | Selection box |
| | religion of you/your | List of all major religions |
| | family | |
| YourActivity1 | Your First Hobbie | Hobbie Name1 |
| YourActivity2 | Your Second Hobbie | Hobbie Name2 |
| PartnersActivity1 | Your Spouse/partners | Partners Hobbie Name1 |
| | First Hobbie | |
| PartnersActivity2 | Your Spouse/Partners | Partners Hobbie Name2 |
| | Second Hobbie | |
| PrincipleWorkingStatus | What is your working | Selection box |
| | status? | Working |
| | | Retired |
| | | Student/Pupil |
| | | Home Maker/Housewife |
| | | Unemployed |
| SpousePrincipleWorkingStatus | What is the working | Selection box |
| | status of your | Working |
| | partner/spouse? | Retired |
| | | Student/Pupil |
| | | Home Maker/Housewife |
| | | Unemployed |
| CompanyName | The | CompanyName |
| | Company/Organisation | |
| | name that you work | |
| | for? | |
| SpousesCompanyName | The | SpousesCompanyName |
| | Company/Organisation | |
| | name that your spouse | |
| | works for? | |
| BusinessOwner | Are you the Business | Check box |
| | owner? | Yes/no |
| SpouseBusinessowner | Is your spouse the | Check box |
| | Business owner? | Yes/no |
| CarTypeSelect | Do you own a | Selection Box |
| | car/motorbike? | Car, Motorbike, None |
| CarTypeSelectSpouse | Does your spouse own | Selection box |
| | a car/motorbike? | Car, Motorbike, None |
| CarType | Your Car or Bike | (Car/Bike) Make/Model |
| SpouseCarType | Type/Model | (Car/Bike) Make/Model |
| | Your Spouses Car or | |
| | Bike Type/Model | |
| PetState | Do you have a pet? | Check box |
| | | Yes/no |
| PetName | What is the Pets Name? | Petsname |
| NumberofPropertys | The no. of properties | Slection box |
| | additional to your | 0, 1, 2, 3, 4 |
| | main residence | |
| Address | The Address of the | Address |
| | house you/your | |
| | spouse/family are | |
| | living in | |
| Address2, 3, 4, 5 | The Address of | Address2, 3, 4, 5 |
| | another property that | |
| | you own/manage e.g. | |
| | investment, holiday | |
| | home, mothers | |
| | home . . . , etc | |
| NumberofChildren | How many | Selection box |
| | Children/Dependents | 1, 2, 3, 4, 5, 6 |
| | are there in your | |
| | family. Include eldery | |
| | parents, children, | |
| | adopted children | |
| Child/Dependent | Choose the type of | Selection Box |
| | Child/dependent for | Your Son (at School) |
| | each member in your | Your Daughter (at School) |
| | family | Your Son (Student/Adult) |
| | | Your Daughter (Student/Adult) |
| | | Dependent Girl (Child at School) |
| | | Dependent Boy (Child at School) |
| | | Dependent Man (Student/Adult) |
| | | Dependent Woman (Student/Adult) |
| | | Dependent Man (Elderly) |
| | | Dependent Woman (Elderly) |
| ChildsName1-6 | Childrens/Dependents | Names 1-6 |
| | Names? | |
| ChildsSchool1-6 | The School's | School/College Names 1-6 |
| | Names/College's | |
| | Names for the | |
| | corresponding | |
| | Childrens/Dependents | |
| ChildsActivity1 (1-6) | Childs/Dependents | Hobbie Name1 1-6 |
| | first Activity/Hobbie | |
| ChildsActivity2 (1-6) | Childs/Dependents | Hobbie Name2 1-6 |
| | Second | |
| | Activity/Hobbie | |
| Create Desktop | Do you want folders | Check box |
| Folders | and shortcuts created | Yes/no |
| | on your desktop | |
| Locate large media | Locate large media | Check box |
| files in separate base | files in separate base | Yes/no |
| folder | folder, this allows the | |
| | principle family data | |
| | directory to remain at a | |
| | reasonable size | |

### Data Entry (Steps 1,2,3)

The user fills in the data fields (Table 1) through the graphical user interface as shown in the exemplary versions in FIGS. 1 and 2.

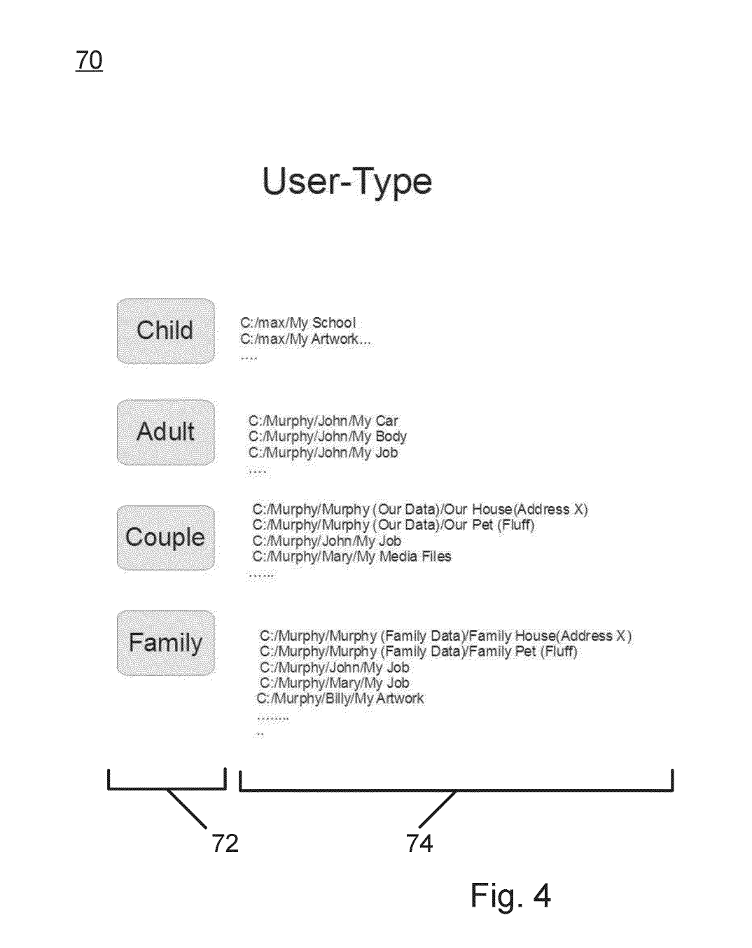

The user's first decision is the main ‘user-type’ or main user/user group of the computer. (Table 1-Field No. 1 & examples 72 of which are shown in FIG. 4 along with exemplary directory structures in abbreviated form 74).

Examples of Possible ‘User-Type’s include but are not limited to the following:
Adult Home Use (One Person Male)
Adult Home Use (One Person Female)
Business Use (One Person)
Household Parent(s) and Children(s) (Family)
Child Home use & School Work (One Person)
Two Adults (Partners)
Two Adults (Female Partners)
Two Adults (Male Partners)

Depending on the ‘User-Type’, there will be an associated PDM Schema which will be different for each of the user-type choices. These standard schemas are suitably created/provided by the providers in advance before providing users with access to the methods.

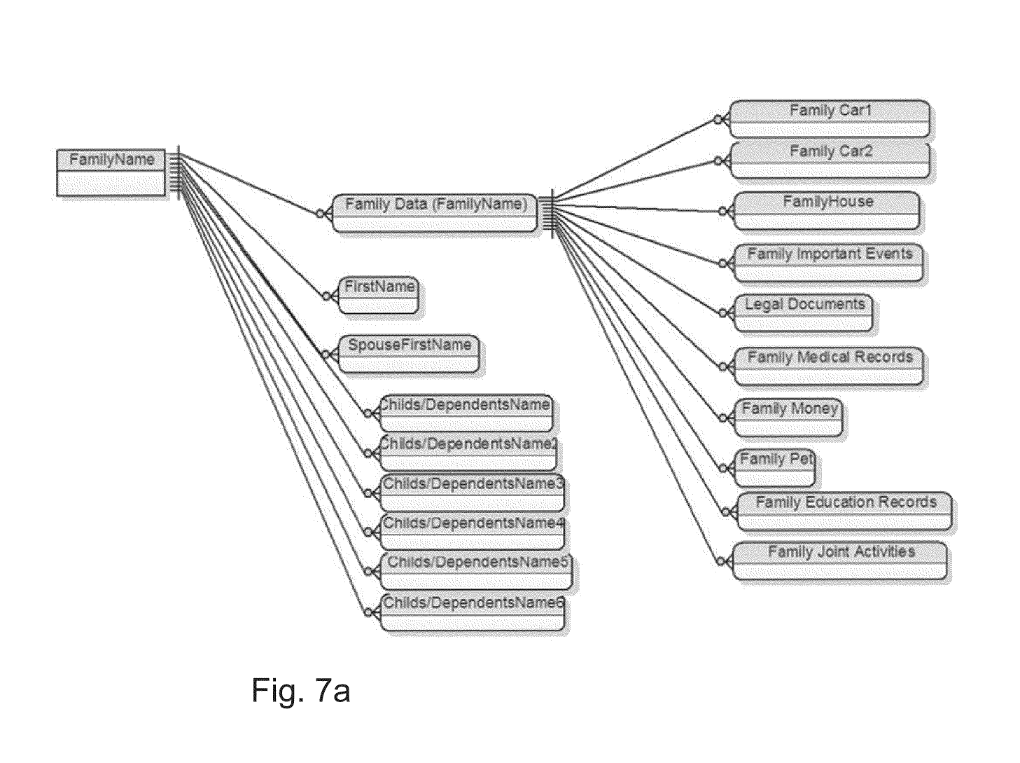

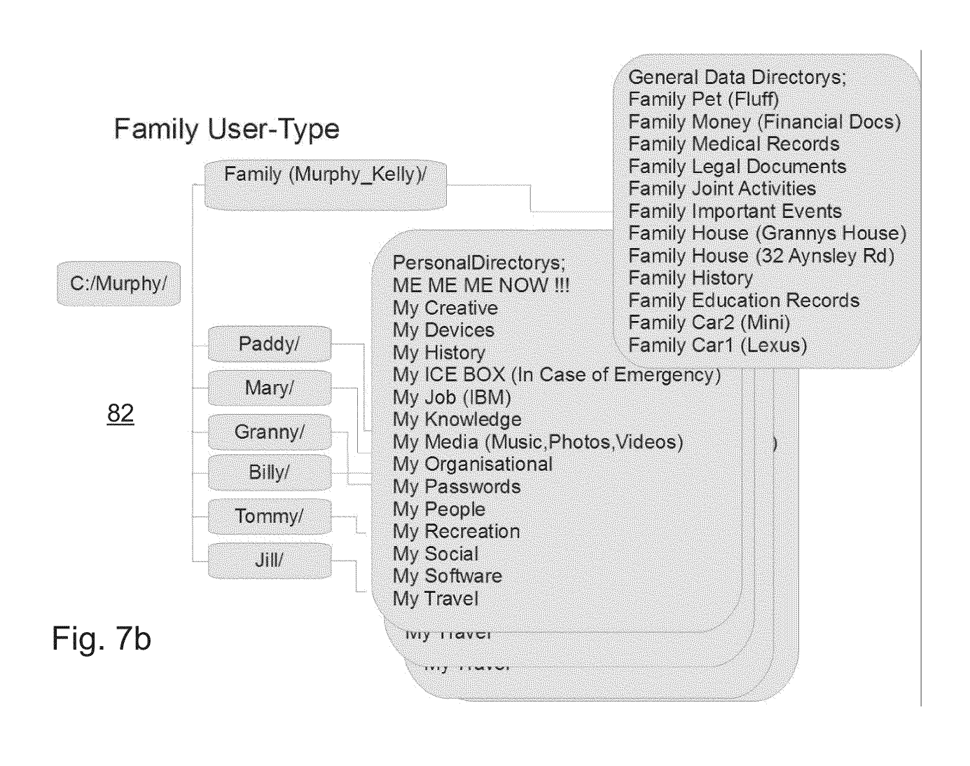

A summarized example of the User Type ‘Family’ schema is illustrated in FIG. 7a, with the resultant deployed ‘User Type’ ‘Family’ directory structure shown in FIG. 7b. It will be appreciated that the summarized form omits further sub directories and is limited to just three levels in a tree structure, whereas in practice there may be four or more.

### Step 2 General Data Entry.

In the Windows-Style GUI application example shown (FIG. 1a) many data entry fields are disabled/enabled dependent on the ‘user-type’ decision, aiding fast completion of data entry. e.g. selection of a user of the ‘user-type’ Adult Home Use′ disables all partner and children fields as the ‘Adult . . . ’ type is to be understood to refer to a single person. In the event that a user elects not to customize their schema, i.e. by leaving default entries unchanged the system proceeds 46 based on the basis of this “default” schema. Alternatively where the user customizes 48 the values, a customized schema results based on the user entered values.

Step 3 refers to the nominated directory location and back up location of directory structure and allows a user to specify 54 where the resulting directory structure is to be stored and backed-up. For example, specific fields 6, 8 may be provided in the graphical interface. The user may also be asked 50 whether they wish to use local storage on their computing device or a remote storage facility for example a cloud storage service such as Dropbox.

Once the user has entered their configuration data by completing Data Entry steps 1,2 & 3 i.e. all fields in Table 1 have been entered/options selected or left with default values (FIG. 2a Windows-Style GUI filled), the system is in a position to implement the second stage which is to create 56 the directory structure and to implement this the user initiates the Directory Deployment Process, for example by clicking an appropriate button 14 in a GUI. As an initial step the users configuration data is saved for future use and possible amendment, for example by the user when their circumstances change. The information may be stored centrally on a server and associated with a user's account or it may also be stored locally in a local user configuration file. The user configuration file containing all users data may be stored in an xml file of the type UserConfiguration.xml_date (FIG. 13)

The configuration data may then be used as the input for the deployment process 56.

### PDM Workflow Step 4 “The Deployment Process”

### (FIG. 3, Step 4)

Once initiated, the directory deployment process 56 uses the supplied personal data either directly from memory or by accessing the previously stored user configuration file. For example, if an executable is employed to create the directory structure, the executable may be run as a command line application including the user configuration file name (UserConfiguration.xml) in the command line, for example if the executable file is called PDM_CMD then the application may be run with this command line syntax; PDM_CMD. exe [param] UserConfiguration.xml.

The deployment process, whether implemented as a command line or otherwise, builds a personalized directory structure. The structure will include personalized titles for at least some of the directories with generic names for the remaining directories.

The directory structure may then be converted into actual directories in a file storage location. The file storage location may be a local drive, networked drive or remote storage.). In the case of remote storage such as, for example, DROPBOX, GOOGLEDRIVE, ZUMODRIVE or SUGARSYNC, the user may be required to log-in to remote storage service and grant access to the application. In such an environment, it will be appreciated that the application may be configured to use one or more API's provided by the remote storage services to create the directories and where appropriate files on the remote storage service.

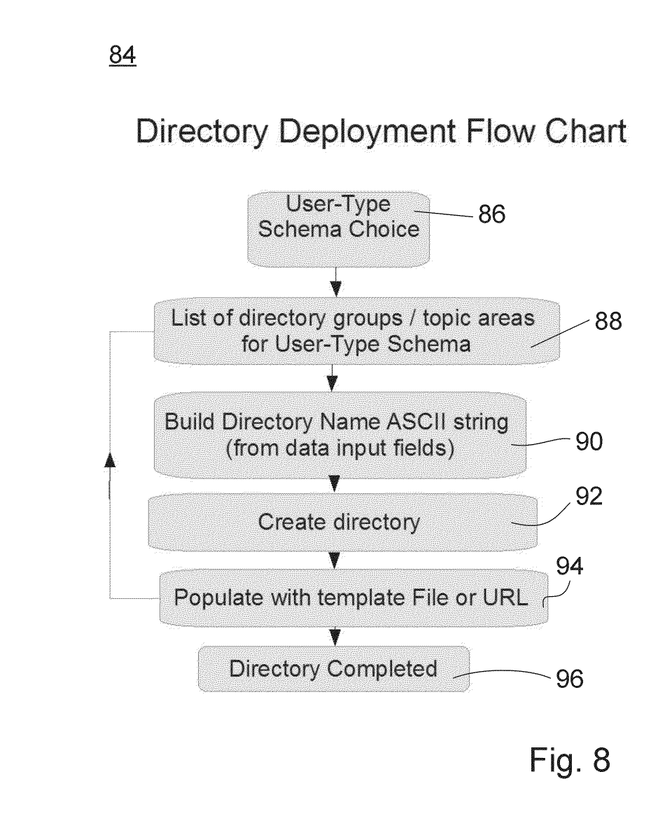

An exemplary deployment process 84 is shown in greater detail in FIG. 8 and commences with the selection of a default schema 86 for the user's particular user type. Each directory in the directory structure in the default schema is considered 88 in turn to determine should it be changed based on the answers provided by the user during the first stage. Where a user has provided an answer the name of the directory is changed 90 or built accordingly. The directory may then be created 92 or saved to a file for subsequent creation in a final stage. Similarly, the created directory may be pre-populated 94 with previously created files for the directory or the files may be created for subsequent populating of the directory structure, for example in the aforementioned final stage. The names of these default files may be changed based on a user's answer to a question presented in the first stage. This is repeated for all required directories until the process is completed 96. In this manner, the created directory structure will include personalized titles for at least some of the directories with generic names for the remaining directories.

This process will now be described in greater detail with reference to FIGS. 8 to 10.

Once the Directory structure is created the user may use 58 it to store information and files relating to their life in an organized and structured way. The previously described graphical user interface may also allow a user to configure a back-up 60.

Each ‘user-type’ schema details a list of ‘topic areas’ or directory groups that should be created. Each individual directory has to be created starting first with the creation of the customized ascii string of the directory name title. The Directory is then deployed using the Directory Build Routine 200 FIG. 10. This is done for all directories listed in the ‘User-type’ Schema, until the structure is complete.

It will be appreciated that in order to create the directory structure, that individual directories must be created.

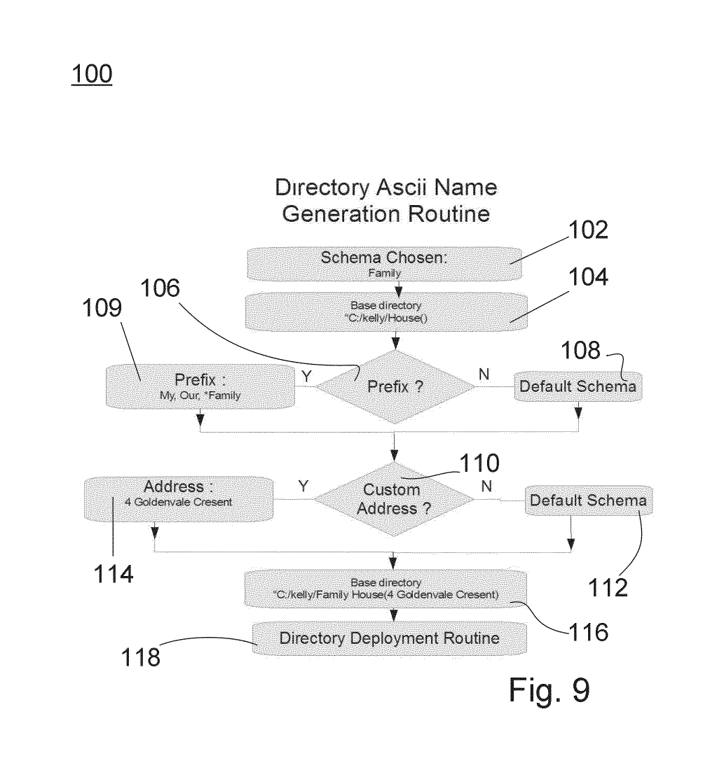

These directories may, for example, be created, with reference to the flow 100 of FIG. 9, by a series of steps 102, 104, 106, 108, 109, 110, 112, 114, 116 which concatenating values entered by the users with data generated by the system based on user selections or inputs so as to create an Ascii String for the Directory Title. Where a user has not provided an answer, a default option may be employed 108, 112. It will be understood, that it is appropriate to generate parent directories before generating child directories in the structure. The created directory string may then be deployed 118.

The base directory names are taken 104 from the relevant ‘user-type’ PDM schema (see for example, exemplary Family Schema—FIG. 7a) and the ‘topic area’ areas for said schema.

The directory customizations may, in generating concatenated values for the directory use any of the text values of any of the data field entries detailed in Table 1, namely;

User Type, HelpType, DestinationDrive, DestinationBackupDrive, FamilyName, FirstName, FirstNameGender, SpousesName,SpousesFamilyName, SpousesNameGender, In a relationship ?, Use SpousesFamilyName as part of Directory structure?, Country,Religion, YourActivity1, YourActivity2, PartnersActivity1, PartnersActivity2 PrincipleWorkingStatus, SpousePrincipleWorkingStatus, CompanyName, SpousesCompanyName, Business Owner SpouseBusinessowner, CarTypeSelect, CarTypeSelectSpouse, CarType, SpouseCarType, PetState, PetName, NumberofPropertys, Address,Address2, 3, 4, 5,Child/Dependent, NumberofChildren, ChildsName1-6, ChildsSchool1-6, ChildsActivity1 (1-6), ChildsActivity2 (1-6),Create Desktop Folders, Locate large media files in separate base folder

It will be appreciated that some of these may be employed in each directory for example “DestinationDrive” may be common to all directory names in the structure, whereas as others may simply be employed in a single directory name in the structure.

The directory customizations will include prefixes that follow the user-type choices;

| User Type | Default Prefix |
|---|---|
| Adult Home Use (One Person Male) | My (e.g. My Car) |
| Adult Home Use (One Person Female) | My (e.g. My Education Records) |
| Business Use (One Person) | My (e.g. My Job (XYZ inc.)) |
| Household Parent(s) and Children(s) | Family (e.g. Family |
| (Family) | House(Address)) |
| Child Home use & School Work (One | My (e.g. My Artwork) |
| Person) | |
| Two Adults (Partners) | Our (e.g. Our Legal Documents) |
| Two Adults (Female Partners) | Our (e.g. Our House) |
| Two Adults (Male Partners) | Our (e.g. Our Medical Records) |

Example Ascii Directory titles; “c:/Kelly/Tim/Car” is typically customized with the ‘CarType’/′SpousesCarType′ data field i.e.“c:/murphy/stephanie/Family Car (Ford Fiesta)”

The user-type schema design allows for easy design additions; topic areas, filenames/urls . . . etc

The core building block routine that allows the creation of complex named and populated directories is a re-usable function called the ‘directory build routine’ 200.

This routine 200 is required for the creation of each directory/sub-directory. The routine takes several parameters (as illustrated in FIG. 10) when called from the main run loop. This routine creates the custom named directory in the nominated location. The ‘directory build routine’ is passed the base name of the directory ‘DirectoryBaselsub’, this is the customized directory name e.g. “c:/kelly/Tim/Car(Ford Escort)”

Additional ‘directory build routine’ parameters can be configured to populate the individual directories within the directory structure with one or more of the following;
a specified file template, with customized filename
an empty text note file with a generic filename, e.g. ‘Note.txt’
an empty text note file with a customized filename, e.g. UserlPetDetails.txt
an empty text note file with filename changed to ‘last directory level’.txt
a Url link http://www.xxx.vvy with customized name and alias

The populated template files, empty text note files and URLs can be renamed/alias′ed using any of the entered data field (Table 1) strings. e.g. a template file called “Neighbour list.txt” gets copied and renamed to “c:/kelly/Tim/Our House(14 Greendale)/Neighbour list (14 Greendale).txt”

### Topic Areas:

The aforementioned ascii name title creation routines and directory deployment routine are used for each of the directory groups/topic areas.

Firstly the algorithm follows the users principle selection for ‘User-Type’ schema structure;
Adult Home Use (One Person Male)
Adult Home Use (One Person Female)
Business Use (One Person)
Household Parent(s) and Children(s) (Family)
Child Home use & School Work (One Person)
Two Adults (Partners)
Two Adults (Female Partners)
Two Adults (Male Partners)

Each of the above schema types has a different sequential list of ‘topic areas’ which build groups of ‘topic area’ directories forming part of the directory structure. When all topic areas are completed for the ‘user-type’ schema the directory structure is complete. It will be appreciated that the names and indeed existence of directories may be configured to change based on a selection made by a user. Thus for example if the user has defined a ‘user-type’ of Family, but there is no partner or spouse, the process will populate the Family directory tree with no partner/spouse directories. It will be understood that different requirements may be imposed on an individual based on their nationality or country of residence. Thus having a directory for ‘property tax’ might make no sense in one country but would be relevant in another. Similarly, certain local taxes may not be applicable in some countries but would be in others. Equally, the names of directories may change. Thus, for example, the directory for property tax associated with a property might be given a directory name of ‘property tax’ in one jurisdiction but ‘rates’ or ‘household charge in another’.

The ‘Legal Documents/Passports/Forms (Gov) directory will for each individual country selected contain the corresponding Passport Application Form in’.pdf format or a link to the correct website location. This ‘/Topic-Forms (Gov)’ sub-directory is consistently used in all relevant areas, such as Driving License Application, Tax Return, Car Registration, . . . etc

Equally, the language employed in the text of the directory name may change based on user selection. Thus if a user selects ‘France’ as their country and French as their chosen language, the language of the form and directories may change accordingly.

In the exemplary schema, there are common or core ‘topic area’ directory groups that are required for all ‘User-Type’ schemas. (Detailed in Topic Area section)

Similarly, in the exemplary schema, there are re-usable ‘topic area’ directory groups that are called on differently depending on the ‘User-Type’ schema. These are required where the ‘user-type’ has multiple family members, property's,cars, pets . . . etc; (Detailed in Topic Area section)

For each directory created the ‘Directory Generation Build routine’ is run (Ref. FIG. 10).

### Directory Group/Topic Areas

The sequence of directory creation follows the ‘topic areas’ of each PDM ‘User-Type’ Schema.

| | Common/ | | | |
|---|---|---|---|---|
| No. | Reusable | Topic Area | Description | Procedure Parameters |
| 1 | C | Family History | inc. CV's, Family Tree, | NA |
| | | | Personal Chronological | |
| | | | History, Professional | |
| | | | Chronological History | |
| 2 | C | Money | inc. Banking | NA |
| | | (Financial | Documents, Monthly | |
| | | Documents) | Yearly, Future | |
| | | | (retirement), Pension, | |
| | | | Tax, Assets . . . | |
| 3 | C | Legal | inc. Birth Certs, | NA |
| | | Documents | Baptism, Driving | |
| | | | License, Passports, | |
| | | | House deeds, Marraige | |
| | | | cert, | |
| 4 | R | TravelDirectory | inc. time tables, trip | (string FirstName) |
| | | Fill | itinerary, travel | |
| | | | insurance, packing | |
| | | | lists . . . | |
| 5 | R | MediaDirectory | inc. music, photos, | (string FirstName) |
| | | Fill | movies, artwork, ebooks, | |
| | | | newspapers, . . . | |
| 6 | R | ImportantEvents | inc. Birthdays, Deaths, | (string directory) |
| | | | Marraiges, | |
| | | | Religious (various) | |
| | | | Celebrations; | |
| | | | Christmas, Communion, | |
| | | | Confirmation, | |
| | | | Halloween . . . | |
| 7 | R | JointFamilyActivities | inc. Family joint | (string directory) |
| | | | activities, e.g. picnic | |
| | | | preparation list, | |
| | | | camping check lists | |
| 8 | R | CarDirectoryFill | inc. insurance, | (string directory, string |
| | | | maintenance, records, | VehicleType, string |
| | | | running costs, service | CarTypeFocus) |
| | | | contacts . . . | |
| 9 | R | PetDirectoryFill | inc. Pet care/health, | (string pets_name, string |
| | | | insurance, pictures . . . | directory) |
| 10 | R | MedicalDirectoryFill | inc, Diet, Fitness, | (string preamble, string name, |
| | | | Health Tracker, Medical | string directory, string Gender, |
| | | | History, insurances, | string AdultChild) |
| | | | records, | |
| | | | medicines/ | |
| | | | prescriptions . . . etc | |
| 11 | R | EducationDirectoryFill | inc. Disciplinary, | (string preamble, string name, |
| | | | schedules, school | string directory) |
| | | | reports, parent teacher | |
| | | | meeting reports, | |
| | | | uniform . . . etc) | |
| 12 | R | PropertyDirectoryFill | inc. House contents, | (string propertyx, string directory) |
| | | | receipts, warrantys, | |
| | | | manuals, insurance, | |
| | | | house services, house | |
| | | | systems, garden . . . etc), | |
| | | | neighbour lists, house | |
| | | | associations, . . . | |
| 13 | R | ChildsDirectory | inc. school, schedules, | (string directory, string |
| | | Fill | subjects, | childsname, string ch_dep, string |
| | | | homework/projects, | school, string activity 1, string |
| | | | trips, diary, phone, | activity2, string addressx) |
| | | | part-time job, | |
| | | | past-times . . . etc | |
| 14 | R | LifeDirectoryFill | inc. creative, | (string FirstName1, string Gender) |
| | | | organizational, | |
| | | | knowledge, recreation, | |
| | | | Job, personal | |
| | | | devices, . . . etc | |
| 15 | R | SpouseDirectory | (as above for | (string directory) |
| | | Fill | spouse/partner) | |
| 16 | R | BusinessOwner | inc. Suppliers, | (string Companynm, string |
| | | DirectoryFill | customers, marketing, | directorybs) |
| | | | employees, business | |
| | | | development, | |
| | | | accounts . . . etc | |

Item10 “MedicalDirectory” suitably includes a sub-directory location called ‘ICE BOX’ which is designed to hold ‘ICE, in-case of emergency’ type information consisting of; Medical Insurances, My Allergy(s), My Blood Type, My Donor card, My Medical Conditions, My Medication(s), My Serious Illness or Death—Special Arrangements, My Will & Testament.

In one embodiment, the system may be adapted to up-load/make available this particular information or aspects of it to the Emergency-Services database.

The re-usable routines allow the creation of hundreds of hierarchical personalized directory locations. This deep web of data locations when deployed help individuals and families decide on accurate logical locations for storage of their electronic data (scanned documents or data files) enabling easier storage (backup) and fast logical retrieval of data.

### PDM Work Flow—Operational Use

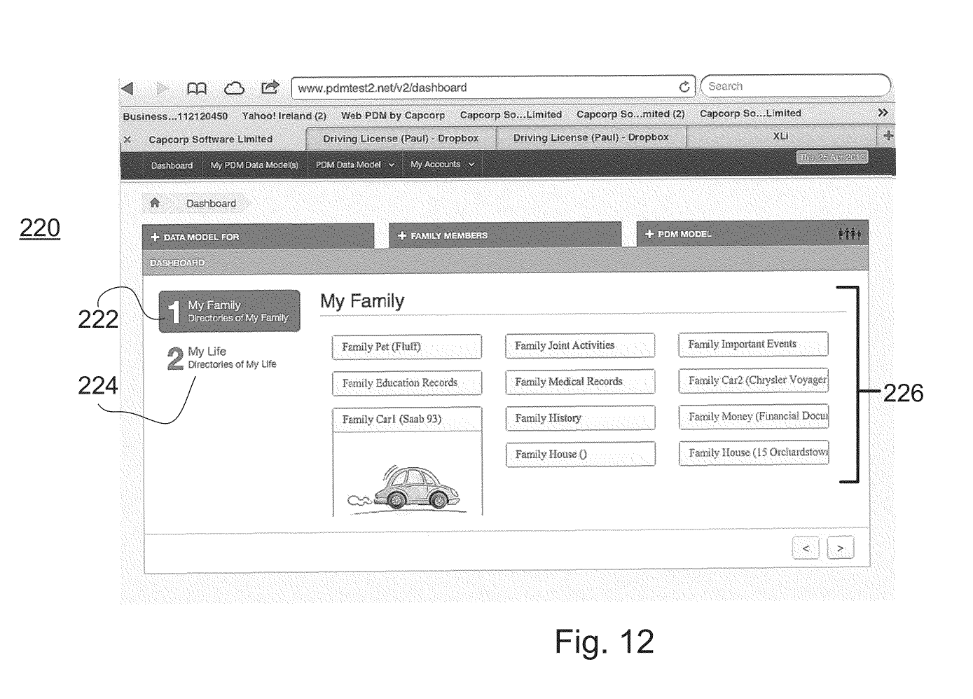

Step 5 of FIG. 3 relates to the daily usage 58 of the directory structure by the individual/Family. User/Users initially go through a set-up process to capture their current Personal documents from paper form by scanning or by copying where already in electronic form. To assist the user, in a first mode the system employs the previously created user configuration file to produce a series of instructions 120 customized for the user detailing the documents in an order 122 to be scanned or otherwise obtained and the location within the created directory structure in which to store them. This series of instructions will be based on the previously supplied user information and identify documents to be scanned from paper form to an electronic document and the appropriate location 128 within the directory structure to store the document along with instructions 130 for the user An exemplary sequence produced for a user is detailed in FIG. 12, and outlines 126 categories of documents Legal Documents, Medical, Insurances, Financial and other types of paper documents that the user may wish to capture and identifies a paper file folder location 124 where the hard copy (paper) copies of the specified documents 126 might be kept. The instructions may also identify information 132, such as passwords, bank account details that a user may wish to enter into a specified file within the directory structure for future reference. Once the initial data capture has been performed the user stores important documents as and when required within the directory structure. Where remote access is enabled on the local drive or where the data is stored in the cloud or other networked arrangement, users may have constant referral access to their data via all modern means; computer/phone/pda/tablet/social media technology.

In a second mode (not shown), the process of data capture may be semi-automated by means of an application which employs the previously created user configuration file to produce a custom series of instructions which are presented to the user in sequence. Each instruction may be presented within a GUI detailing the document required. The user may be given an option within the GUI to identify the location where the document is stored if it has previously been saved to the computing device or to allow the user to capture the document using an attached scanner or other imaging device. This is particularly advantageous where the computing device is a smart phone or similar hand held device with an integrated camera. At each stage, where a user identifies the required file or captures it, the application stores the file in the appropriate place in the directory structure. The application may allow the user to skip particular documents or to repeat the process for documents not captured previously.

Step 6 relates to the backup procedures to safeguard the data A scheduled process 60 may be put in place to regularly copy the single root directory structure (and all of the contents thereof) to a secure location. It will be appreciated that such a backup process may be triggered on a regular basis, e.g. weekly, monthly, quarterly or yearly basis.

Similarly, at Step 7, the system may check 62 for updates to the schema from a central repository associated with the system. Where an update is found a user may be provided with the option to proceed with an update. Such an update may rename a directory in a structure or add in another directory. Similarly default files may be added or replaced with an update. For example, a directory in the structure might be provided for a user's tax affairs which in turn may be broken down into years. A blank tax return form may be inserted into the directory for a particular year, and in a subsequent year during an update the latest version of that form may be saved in the directory for the current year. By this means, a user is saved the trouble of having to find forms on-line when preparing their tax returns. It will be appreciated that this may equally be applied to other aspects of a person's life. It will be understood, that the default forms provided to a user would depend on answers they have previously provided including their country of residence. Thus a deployed data structure may be updated with latest file templates or enhanced directory ‘spurs’ . . . etc from changes to the structure which have been implemented since the last check.

### Local Storage/Remote Storage Notes:

The location of the customized directory structure may be in a directory associated with another program. Thus for example, the customized directory may be provided as a sub directory of a synchronized folder stored locally on the computer wherein an application on the computer is employed to synchronize the contents of the local folder with a remote folder, which may for example be provided by a server on the Internet.

This style of “single-base-directory/tree model’ data organization compliments centralized backup services and remote access to data. An example of such a program\service is that provided by Dropbox Inc. of San Francisco along with the other examples described above. The synchronized DROPBOX folder may be accessed by the user/family remotely via all modern communication means; computer/phone/pda/tablet/social media technology etc.

Indeed, the present application provides a convenient graphical user interface which allows a user to readily access the information stored in their customized directory structure in a convenient fashion and is particularly suited to access from a PC or tablet computer or smart phone where the data is stored using a remote storage facility such as DROPBOX. In particular, the

Application which will be referred to herein as the ‘Dashboard’ may be implemented as an OS specific application or indeed as a web based application that allows the user rapid shortcut based access to their personal data stored on their PDM data model, i.e. the files stored within and comprising the directory structure. In brief, the application creates graphical icons for different points of interest within the directory structure. These points may the primary directories within the structure. The graphical icons would have associated links such that when a user clicks the icon they are taken to the link. In this way, the user is brought immediately to a point of interest within the directory structure. The application may be a customized webpage which is created for a user and stored either on their computing device or on a remote server where it may be accessed by a username and password. The webpage may for example be stored in the root folder of the directory structure as an index.html so that a user opening the root folder in a browser is presented with the webpage by default.

The dashboard creates rapid access to the user's personal data files stored within the previously created directory structure. The access, if through a browser, may be restricted to read access. The graphical icons in the dashboard are not restricted to points of interest in the directory structure and may for example also be directed to web services such as email, on-line calendars, social networking accounts etc, in this way the application or webpage becomes a portal for a person to access their on-line life.

In one implementation, the dashboard consists of a matrix or ‘desktop’ area where the user can move around graphical icons; with each graphical icon providing a link to a type ‘a’ or a type ‘b’ destination. The type ‘a’ destinations are links to points of interest within the directory structure previously described, whereas the type ‘b’ destinations are user configurable, for example to web services such as email (e.g. gmail/yahoo).

Default icons may be created for each primary destination. The application may allow these to be changed. For example the icon link to a user's house directory could have a picture of the users house or a simple graphic of a house on the icon. In the case of a family, couple or otherwise linked users, the application may create linked directories between different users. Alternatively, one user may be created as the administrator as such. The administrator (e.g. Parent) may then grant access to the user (e.g Child) to particular points in their directory structure.

In another embodiment which may be a part of the dashboard or separate thereto an index file may be created using the information submitted by the user and the resultant directory structure created in which all documents and types of documents may be listed, with links to the location in the user's personalized file directory structure where these documents may be stored to facilitate fast access to individual documents as required so as to provide an alternative mode of navigation to that of the dashboard or by browsing the directory structure directly. In an optional implementation, the application creating the index may search the personalized directory structure and add information to the index from files identified in the search.

The computer implemented method may also provide for the generation of a physical paper file structure. This physical file structure may be used to store hard-copies of documents associated with the personalized file directory structure, for example originals of documents which are stored as soft copies in the directory file structure. The generated physical file structure may comprise the preparation and printing of appropriate labels for use with a file folder or filing cabinet or may comprise the production of custom file folders. The labeling in each case corresponds to an identifier within the directory file structure, which may for example be the folder name, the directory name, allocated reference number or combination thereof

### Machine Architecture

FIG. 14 is a block diagram, illustrating a diagrammatic representation of machine 900 in the example form of a computer system within which a set of instructions for causing the machine to perform any one or more of the methodologies discussed herein may be executed. In alternative embodiments as discussed above, the machine 900 may operate as a standalone device or may be connected (e.g., networked) to other machines. In a networked deployment, the machine 900 may operate in the capacity of a server or a client machine in a server-client network environment, or as a peer machine in a peer-to-peer (or distributed) network environment to implement the browser implementations or cloud storage discussed above.

The machine 900 may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 may include a processor 960 (e.g., a central processing unit (CPU), a graphics processing unit (GPU) or both), a main memory 970 and a static memory 980, all of which communicate with each other via a bus 908. The computer system 900 may further include a video display unit 910 (e.g., liquid crystal displays (LCD) or cathode ray tube (CRT)). The computer system 900 also may include an alphanumeric input device 920 (e.g., a keyboard), a cursor control device 930 (e.g., a mouse), a disk drive unit 940, a signal generation device 950 (e.g., a speaker) and a network interface device 990.

The disk drive unit 940 may include a machine-readable medium 922 on which is stored one or more sets of instructions (e.g., software 924) embodying any one or more of the methodologies or functions described herein. The software 924 may also reside, completely or at least partially, within the main memory 970 and/or within the processor 960 during execution thereof by the computer system 900, the main memory 970 and the processor 960 also constituting machine-readable media.

The software 924 may further be transmitted or received over a network 780 via the network interface device 990.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

Thus, a method and a system for creating a customized directory structure in which a user may store their personal information and records have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with formal requirements including 37 C.F.R. §1.72(b) in the US, requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

While the present invention has been described in connection with the preferred embodiments of the various Figs., it is to be understood that other similar embodiments may be used or modifications and additions may be made to the described embodiment for performing the same function of the present invention without deviating therefrom.

1. A computer implemented method for creating a personalized file directory structure for use by a user to store personal information of the user, the method comprising the steps of:
obtaining an identification of a user-type from the user where the user-type identifies whether the directory structure, is for an individual or several individuals grouped together for example as a couple or a family and selecting a directory schema for the personalized file directory structure based on the identification of user-type;
obtaining a plurality of answers from the user as to their personal circumstances;
creating a personalised file directory schema from the selected directory schema based on the identified user type and the obtained plurality of answers;
wherein the obtained answers are employed to enrich a plurality of directory names within the schema and where the schema identifies the directories for the personalized file directory structure.

2. The computer implemented method of claim 1, further comprising the step of receiving of an indication of a location for placing the personalised file directory structure from the user and further comprising the step of creating the directories of the personalised schema at said location to provide the file directory structure.

3. The method of claim 1 further comprising the step of creation of graphical user interface, the graphical user interface comprising a plurality of icons each icon having an associated link which may be linked through to by a user clicking the icon wherein a plurality of the associated links are to points internal to the personalized file directory structure.

4. The method of claim 3, wherein one or more of the associated links may be a link to a browser accessible account of the user.

5. The method of claim 4, wherein the browser accessible account of the user may comprise one of more of the following:
a) a social media account of the user,
b) an email account of the user,
c) a diary or schedule of the user, and
d) a web link (url).

6. The computer implemented method of claim 1, wherein the identification of user-type and the plurality of answers are obtained from the user by presenting the user with a series of questions, wherein the selection of a subsequent question may be based on an answer obtained from a previous question.

7. The computer implemented method of claim 6, wherein the questions are presented to the user using a graphical user interface having different entry fields and wherein completion of a field in the graphical user interface may trigger the disabling of identified unnecessary data fields within the application GUI as a result.

8. The computer implemented method of claim 1, wherein a user is required to select their Country of residence and wherein the method populates the directory structure with default directories previously defined for said selected country.

9. The computer implemented method of claim 6, further comprising the step of populating the default directories with one or both of Local forms or URL links previously defined for said selected country.

10. The computer implemented method of claim 1 further comprising the steps of:
presenting the user with one or more of the following questions, each question presented having a plurality of predefined answers from which the user can select said one or more questions comprising:
Marital status of the user;
Dependent—child, elderly parent, young adult;
Employment status of the user;
Mode of transport of the user;
Nature of residence of the user; and
Religion of the user;
obtaining one or more answers from the user; and
populating the schema with default directories previously defined for each answer.

11. The computer implemented method of claim 1, wherein the personalized file directory structure comprises a tree directory structure with a single root sub-directory in which all of the remaining directories are contained.

12. A non-transitory computer-readable storage device storing computer-executable instructions, which when executed by one or more processors of a computing device, cause the one or more processors to perform the method of claim 1.

13. A computer system comprising:
memory for file storage;
a display;
a graphical user interface for interacting with a user of the computer system;
a personalised file directory structure for the user within the file storage memory created for a user based on answers provided by the user to questions presented through the graphical user interface;
and wherein the graphical user interface provides a user with a plurality of icons providing direct access to directories within the personalised file directory structure.

14. The computer system for creating a personalized file directory structure of claim 13, the system further comprising means for receiving an indication of a location for placing the personalised file directory structure from the user and wherein the means for creating a personalised file directory schema is configured to create the directories of the personalised schema at said location to provide the file directory structure.

15. The computer system for creating a personalized file directory structure of claim 13, further comprising means for creating a graphical user interface, the graphical user interface comprising a plurality of icons each icon having an associated link which may be linked through to by a user clicking the icon wherein a plurality of the associated links are to points internal to the personalized file directory structure.

16. A computer system for creating a personalized file directory structure for use by a user to store personal information of the user, the system comprising:
means for obtaining an identification of a user-type from the user where the user-type identifies whether the directory structure, is for an individual or several individuals grouped together for example as a couple or a family and selecting a directory schema for the personalized file directory structure based on the identification of user-type;
means for obtaining a plurality of answers from the user as to their personal circumstances;
means for creating a personalised file directory schema from the selected directory schema based on the identified user type and the obtained plurality of answers;
wherein the obtained answers are employed to enrich a plurality of directory names within the schema and where the schema identifies the directories for the personalized file directory structure.
